(19) United States
(12) Patent Application Publication
(10) Pub. No.: US 2004/0189555 A1
(43) Pub. Date: Sep. 30, 2004

(54) Use of track lighting switching power supplies to efficiently drive LED arrays

(76) Inventors: Larry Stephen Capen, Oceanside, CA (US); William Grant Anderson JR., Fallbrook, CA (US)

Correspondence Address: ROBERT NATHANS, 36 STAG DRIVE, BILLERICA, MA, 01821, US

(21) Appl. No.: 10/397,763

(22) Filed: Mar. 26, 2003

(51) Int. Cl. G09G 3/32; H05B 37/02

(52) U.S. Cl. 345/82; 315/291

(57) ABSTRACT

A power conditioning circuit is coupled between a conventional low-voltage 12 volt AC switching power supply used in track lighting arrangements and an LED array used for illumination of an area. A conventional voltage multiplier is provided having a low input impedance for producing a current inrush from the switching power supply, sufficient in magnitude and duration to excite the low-voltage switching supply in spite of the low LED load to be energized. The resulting voltage multiplied and rectified current is fed to a precise DC voltage regulator for very efficiently driving an array of series-parallel strings of light emitting diodes. The use of the voltage multiplication combined with precise DC voltage regulation feature enables driving LED arrays having the longest possible light emitting diode serial strings for the available voltage, increasing energy efficiency while keeping the circuit near ambient temperature.

### BACKGROUND OF THE INVENTION

This invention relates generally to the field of solid state lighting and more specifically to a power conditioning circuit for efficiently driving light emitting diodes.

The lamps used on low voltage track lighting, typically MR-16 halogen bulbs, use large amounts of power to operate, ranging from 1.6 amps for the 20 watt version up to 4 amps for 50 watt lamps. As halogen lamps are incapable of delivering anything but white light, there has been great interest in the lighting industry in providing light emitting diode-based replacement lamps. These solid state lamps have a number of advantages, including far lower power consumption ( typically drawing 120 to 300 mA), cool operation, and the ability to offer lamps of many different colors.

In order to operate light emitting diode-based lamps on 12 volt AC track lighting, the voltage must first be converted to DC. This is typically accomplished by passing the 12 volt AC input through a conventional full wave bridge rectifier, smoothing the output with an electrolytic capacitor, then regulating the output voltage with a zener diode. While this technique works reasonably well with filament transformers, it is either highly inefficient or, worse yet, incapable of providing adequate power when used with the commerically available high frequency switching power supplies commonly used with low voltage track lighting.

The inefficiencies of these circuits lead to higher energy usage, energy wasted as heat, decreased lamp life, and low light output. The techniques of the present invention offer improved energy efficiency, cool operation, and optimum lamp life and light output. The full wave bridge rectifier can be either a single integrated circuit or discrete diodes. Sometimes Schottky diodes are used in place of conventional rectifier diodes to reduce the voltage drop produced across the bridge (typically 0.6 volts instead of the 1.4 volt drop seen when using rectifier diodes).

If voltage regulation is required, this is usually provided by either a zener diode or metal oxide varistor. While conventional AC to DC conversion circuitry works well when the input voltage is supplied by a filament transformer, low voltage track lighting power may also be delivered by any of a number of smaller and more economical high frequency switching transformers. Conventional full wave bridge rectifiers generate considerable amounts of heat when used on high frequency switching power supplies. Not only does this add extra heat to the rest of the circuit from heat sinking through the leads of the bridge rectifier, it also indicates the bridge rectifier is wasting energy. A discrete bridge constructed of Schottky diodes is also very inefficient at frequencies above 60 Hz. The circuit of the present invention uses a voltage multiplier rather than a conventional bridge rectifier, runs more efficiently on high frequency switching power supplies, and operates at only a few degrees above ambient temperature.

The voltage drop across the diodes of a conventional bridge rectifier also reduces the output voltage available to drive the light emitting diodes. Light emitting diodes are typically connected as parallel strings of series connected LEDs. As current driven devices, a string of light emitting diodes uses the same amount of energy whether it is made up of one or many diodes, the limiting factor being the voltage available to overcome the threshold required to enable the diodes to open and operate. The more strings of light emitting diodes connected in parallel, the greater the energy needed to operate them. Thus the voltage drop across the diodes of a conventional bridge rectifier necessitates using shorter strings of light emitting diodes, and having more strings in parallel, which increases the power requirements of the circuit. By using a voltage multiplier, the present invention not only eliminates the bridge rectifier's voltage drop, it increases the voltage available to the light emitting diodes. This allows one to use longer strings, and fewer parallel strings, giving significant energy savings.

The excess heat generated by conventional bridge rectifiers also affects the light emitting diodes. Light emitting diodes are rated for operation at a specific ambient temperature and current. If they are operated at higher than their typical current, the diode junction operates at a higher temperature and their operating life is reduced. Conversely, if the ambient temperature is higher than that for which a light emitting diode is rated, it must be run with lower current in order to meet it's maximum operating life. Part of the excess heat generated by conventional bridge rectifiers operating on high frequency switching power supplies will sink through the component leads and into the circuit board, eventually reaching the light emitting diode junctions. If the current is not reduced to compensate for this increased heat, the light emitting diodes will have a markedly shortened operating life. If the current is reduced, though, to maintain their rated lifespan, the light emitting diodes will have a lower light output. Since the circuit of the present invention produces very little heat above ambient temperature, the current supplied to the light emitting diode strings can be closer to their ideal typical rating, giving both long life and optimal light output.

A major problem faced by use of conventional bridge rectifiers and solved by the present invention is that the switching power supplies on low voltage track lighting are designed to operate only if they detect a suffiently large load, such as the 20 Watt MR-16 halogen bulb typically used in low voltage track lighting applications. This can protect the user from being shocked in the case of a broken bulb. Most light emitting diode circuits designed as replacements for MR-16 bulbs use less than a tenth of the power required for a halogen bulb. This is typically too low to excite a switching power supply, which means the power supply will either remain off or will operate irregularly, causing blinking, flashing, or low light output. In accordance with a key feature of the present invention, the capacitor current inrush in the first stage of the voltage multiplier is large enough and long enough (a minimum of four milliseconds), to excite most commercially available switching power supplies so that they provide adequate power to drive light emitting diodes optimally.

Controlling current in circuits designed to drive light emitting diode strings is particularly challenging. Each string of light emitting diodes has its own current limiting resistor, sized to match that part of the available input voltage not being used by the diode string. Thus the closer the voltage required by the string is to the available input voltage, the smaller the current limiting resistor should be. For maximum energy efficiency the designer's goal is to make the light emitting diode strings as long as possible, so the amount of energy wasted in the current limiting resistor will be as small as possible. But if the circuit design uses the longest possible light emitting diode strings for the available voltage, the current limiting resistor for each string will be so small as to be ineffective in preventing the light emitting diodes from controlling current changes, allowing the LEDs to shift away from their ideal designated current. This will cause either poor light output or overdriving of “current hogging” light emitting diodes in the strings, shortening their operating life. A zener diode regulated circuit not only wastes any excess voltage in the circuit by shunting it to ground, which adds unwanted heat to the circuit, it doesn't control the output voltage tightly enough to maintain the designed current for the light emitting diode load. To compensate for this, designers either use shorter light emitting diode strings, reducing their sensitivity to voltage irregularities at the cost of higher energy use, or their designs limit current to the highest expected voltage, thereby causing reduced light ouput at normal or lower voltages. In the present invention, our circuit, in comparison, uses a standard voltage regulator to tightly control the output voltage, maintaining tight control of the voltage available to the light emitting diode strings, keeping them from operating outside their design parameters. This allows the use of the longest possible light emitting diode strings for the available voltage, increasing energy efficiency while keeping the circuit near ambient temperature.

### BRIEF SUMMARY OF THE INVENTION

A particularly important object of the invention is to provide an improved power conditioning circuit configuration that properly excites low voltage alternating current switching power supplies.

Another object of the invention is to provide an improved circuit configuration for driving LED strings that employs a voltage multiplying circuit to convert alternating current to higher voltage direct current.

Another object of the invention is to drive light emitting diode configurations with improved efficiency by providing higher driving voltages which allows longer series strings of light emitting diodes to be operated.

A further object of the invention is to improve the stability of current driven light emitting diode configurations through precise voltage regulation.

The objects of the invention are attained by providing a voltage multiplier having a low input impedance for producing a current inrush from the switching power supply, sufficient in magnitude and duration to excite the low-voltage switching supply in spite of the low LED load to be energized. The resulting voltage multiplied and rectified current produced by a conventional voltage multiplier circuit is fed to a precise DC voltage regulator for very efficiently driving an array of series-parallel strings of light emitting diodes. The power conditioning circuit's use of voltage multiplication (e.g. 12 volts AC to 25 volts DC) combined with precise DC voltage regulation enables driving LED arrays having the longest possible light emitting diode serial strings for the available voltage, increasing energy efficiency while keeping the circuit near ambient temperature.

### BRIEF DESCRIPTION OF THE DRAWINGS

FIG. 1 shows a prior art standard method for generating a regulated DC voltage from an AC input generated by a switching power supply.

FIG. 1a discloses an electrical schematic of a presently preferred embodiment of the invention employing voltage doubling.

In FIG. 2, a voltage booster or voltage multiplier circuit provides a voltage tripling function on the AC voltage provided on the first and second output terminals of a switching power supply; and

FIG. 3 shows an N-stage conventional voltage multiplier circuit. It has similar components as in FIGS. 1 and 2 except for the multiplier circuitry 38b.

Other objects, features and advantages of the invention will become apparent from the following detailed description, taken in conjunction with the accompanying drawings, wherein, by way of illustration and example, various embodiments of the present invention are disclosed.

### DETAILED DESCRIPTION OF PREFERRED EMBODIMENTS OF THE INVENTION

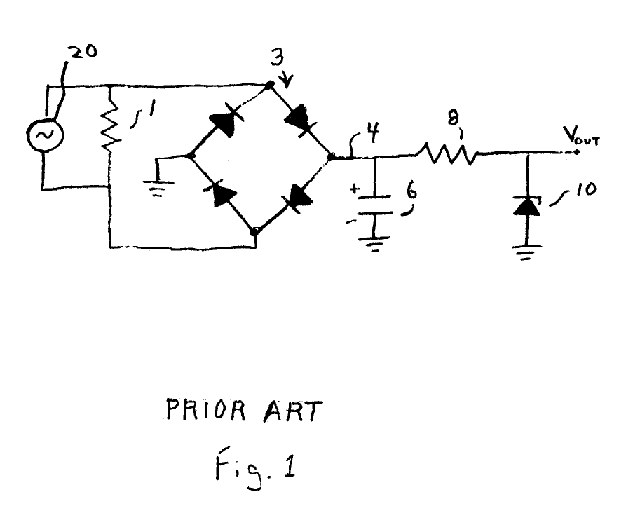

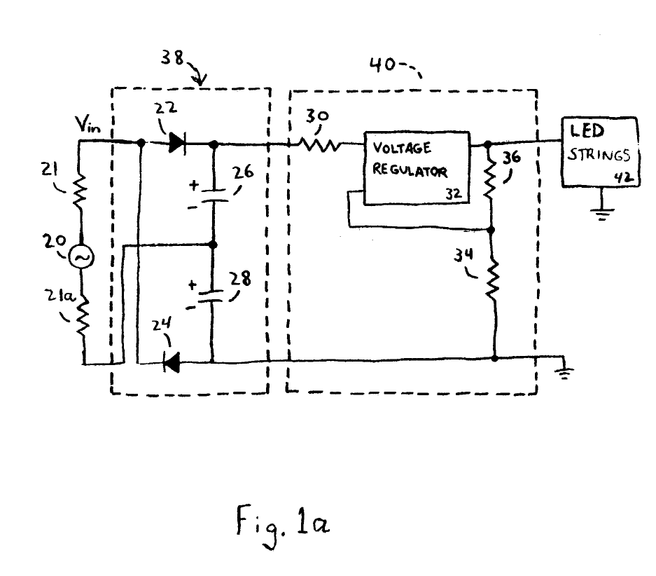

FIG. 1 shows the aforesaid prior art standard method for generating a DC voltage for illumination purposes from an AC switching power supply. A resistor 1 is coupled across the output terminals of AC switching power supply source 20 to provide the current necessary to excite the switching power supply. A standard full wave diode bridge 3 rectifies the AC input to produce a pulsed DC output at 4. An optional tanking capacitor 6 can provide smoothing of the pulsed DC output from the bridge rectifier. A resistor 8 and zener diode 10 regulate the output voltage. While this circuit will excite a switching power supply and provides a somewhat regulated output voltage, it is highly inefficient. All of the current passing through the resistor 1, used to excite the switching power supply, is wasted and converted to heat. The output voltage is only weakly regulated, and again any excess current passes through the zener diode 10 as waste, generating more heat. The voltage regulation is too weak to drive LED strings efficiently.

FIG. 1a illustrates in partial block diagram form and partial schematic diagram form a voltage boosting, rectifying, and regulating circuit in accordance with a presently preferred embodiment of the invention. A switching power supply 20 produces high frequency 12 volts AC upon the two input terminals of voltage boosting circuit 38, in turn coupled to voltage regulator circuit 40. Voltage boosting circuit 38 includes diodes 22 and 24, and capacitors 26 and 28 cascaded together as shown. A positive terminal of diode 22 and a negative terminal of diode 24 are conected to a first upper output terminal of switching power supply 20. Diode 24 has a positive terminal connected to ground as is the lower plate of capacitor 28. Capacitor 26 has a first plate electrode connected to the negative electrode of diode 22, and a second plate electrode connected to a second output terminal of switching power supply 20. Capacitor 28 has a first plate electrode connected to the second plate electrode of capacitor 26, and a second plate electrode connected to the positive terminal of diode 24.

Voltage booster or multiplier circuit 38 provides a voltage doubling function on the AC voltage fed thereto by switching power supply 20. In addition to doubling the voltage, diode 22 and 24 are used to rectify the AC voltage as is understood in the art by those familiar with conventional voltage multipliers. Importantly, capacitors 26 and 28 have a capacitance selected to provide sufficient current inrush in intensity and duration to excite switching power supply 20, enabling its use for driving LED strings having light electrical loads.

Voltage regulating circuit 40 includes resistors 30, 34, and 36, and voltage regulator 32. Resisitor 30 has a first terminal connected to the first plate electrode of capacitor 26, and a second terminal connected to the first input terminal of of voltage regulator 32. Resistor 34 has a first terminal connected to the second input terminal of voltage regulator 32, and a second terminal connected to the second plate electrode of capacitor 28 and ground. Resistor 36 has a first terminal connected to the output terminal of voltage regulator 32, and a second terminal connected to the first terminal of resistor 34.

In voltage regulating circuit 40, resistor 30 is only needed if the input voltage exceeds 60 volts, otherwise it is replaced by a jumper. Resistors 34 and 36 are needed only if voltage regulator 32 is used in an adjustable design. If voltage regulator 32 has a fixed output voltage, resistor 36 is removed, and resistor 34 is replaced by a jumper. In response to receiving the boosted and rectified voltage from voltage boosting circuit 38, voltage regulating circuit 40 provides a boosted and regulated doubled output voltage out applied across parallel string LED array 42, where the boosted and regulated output voltage is referenced to a second power conditioning supply terminal connected to ground as shown. Voltage regulator circuit 40 regulates the doubled output voltage to be relatively constant over the expected input voltage range and current load conditions. Note that in the illustrated embodiment, voltage regulator circuit 40 provides a voltage which is approximately double the peak sensed switching power supply voltage (less losses due to regulation), but in the other embodiments described below, the output voltage may be a different multiple of the peak sensed voltage. Dropping resistors 21 and 21a can be provided to allow the circuit to be operated on any AC voltage from 12 volts up, simply by changing their value to produce the desired input voltage to voltage booster 38.

In FIG. 2, voltage booster or voltage multiplier circuit 38a provides a voltage tripling function on the AC voltage applied thereto. Diodes 44, 46, and 48 along with capacitors 50, 52 and 54 provide this function. In these conventional voltage multipliers, half-wave rectifiers charges successive capacitors connected in series on alternate half-cycles.

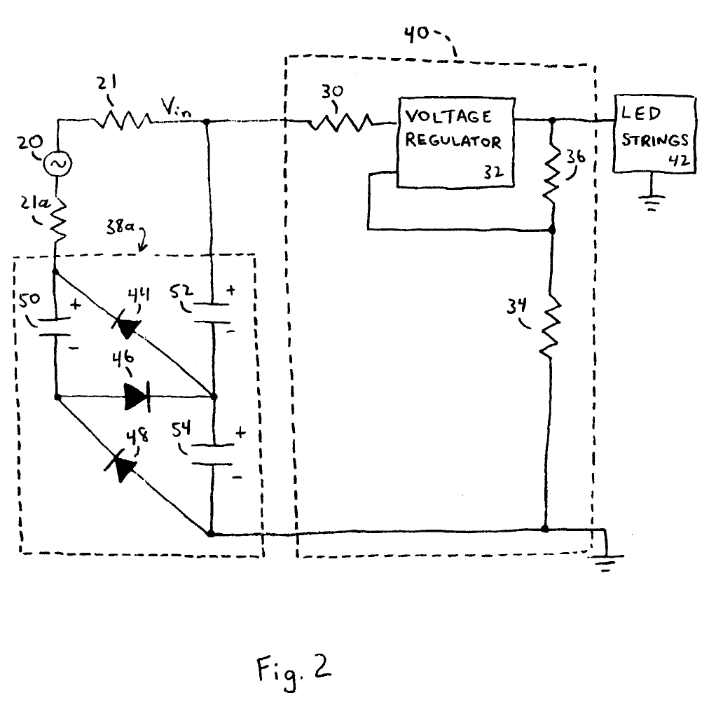

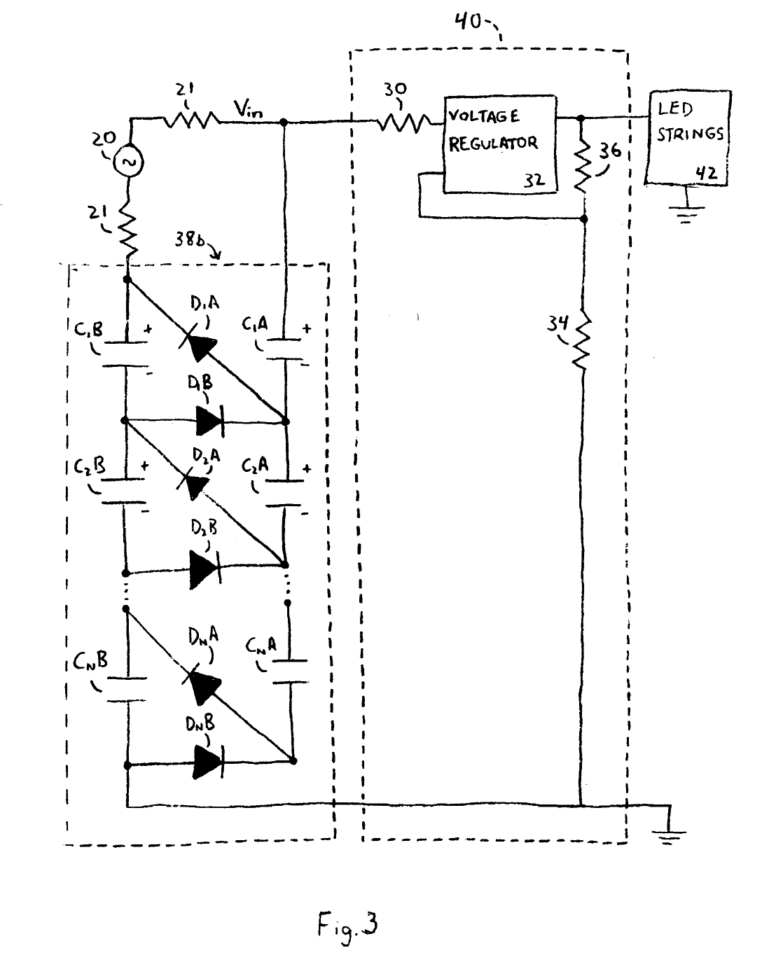

FIG. 3 shows an N-stage conventional voltage multiplier circuit. It has similar components as in FIGS. 1 and 2 except for the multiplier circuitry 38b.

In this figure, the multiplying circuitry can be extended as a ladder as far as desired, limited only by the requirements of the voltage regulator 32 used and the amount of current required for the group of LED strings 42 (the higher the voltage is multiplied, the lower the current that can be produced). Each stage of the multiplier 38b is denoted by its subscripted number. The first (doubling) stage consists of diodes D₁A and D₁B, and capacitors C₁A and C₁B. The second (quadrupling) stage consists of diodes D₂A and D₂B, and capacitors C₂A and C₂B. The Nth stage consists of diodes D_{N}A and D_{N}B, and capacitors C_{N}A and C_{N}B.

Study of U.S. Pat. No. 6,157,551 to Barak et al. and assigned to “Lightech Electronics Industries Ltd”, incorporated herein, reveals the operation of typical low-voltage track type lighting switching power supplies. In an effort to reduce the size of the transformer used in low-voltage switching power supplies designers raised the internal frequency from a typical 50-60 Hz (120 vac line frequency) to a typical 12 vac 20-40 kHz output. The typical power supply design includes methods to simulate a typical sinusoidal 60 Hz output waveform (Barak, FIG. 4).

Additionally, it is typical for designers of low-voltage switching power supplies, as used in track type lighting, to include methods to shutdown the power supply in the event of overload, or an under-load condition possibly caused by a broken bulb with exposed electrical contacts.

Low-voltage (typically 12 vac) halogen bulbs, as typically used in track type lighting fixtures have a typical power rating of 20-55 watts. Low-voltage power supply designers must work within the expectation of delivering at least 20 watts if a working bulb is connected, and up to 55 watts if the largest typically available bulb is installed. Therefore the methods used to convert supply voltage (typically 110-125 vac) into track voltage (typically 12-14 vac), and provide under/over load protection, are typically designed to assume a fault condition if the load is less than 15 watts or more than 60 watts for a single bulb fixture. Multiples of the minimum and maximum parameters are used when the design will be used in multiple bulbs per single power supply designs.

Methods used in the design of typical low-voltage switching power supplies discussed in the aforesaid Barak et al. patent, require a minimum load of 15-20 watts for the power supply to operate as designed. Conversely, a typical lighting design configuration using light emitting diodes (LEDs), applicable to low-voltage track type lighting, will produce an electrical load of less than 2 watts. In this condition, the typical low-voltage switching power supply will produce either no output voltage or a low and erratic output.

Designs include methods to limit or interrupt output voltage when operated outside design parameters. A closer study of typical low-voltage switching track lighting power supplies on the test bench shows a typical window of 4-100 milliseconds during which impedance measurements are taken by the typical power supply design methods to determine if the load (bulb) is operating within design specifications.

The present invention claim exploits this window providing a significant load to the typical low-voltage switching power supply, as used in track type lighting, to excite the power supply into another cycle of output within design specifications. The method used in our design incorporates the use of sufficient rectified in-rush current to an electrolytic capacitor to simulate the design load on the typical power supply.

In our novel, but not obvious method, we are able to excite the typical low-voltage switching power supply as used in track type lighting to full design voltage (typically 12-14 vac) at sufficient current (>500 ma) to power a typical LED designed track lighting product.

Another benefit to this method is the boosting of the supply voltage from a typical 12-14 vac to a typical 23-27 vdc. Another advantage to this method is the rectification of AC to DC in the process of exciting the power supply and tanking the resulting power to reduce ripple current into the regulator. This simplifies the components required and reduces power losses in the design. Additionally, boosting the supply voltage to the regulator allows for greater voltage output to the LED strings than would be possible using only the rectified supply voltage without voltage boosting. This is a great benefit as each string of LEDs consumes the same amount of current regardless of the number of LEDs in the string. It is the available supply voltage to the LED string that determines the number of LEDs that can be attached to each string. In summary, the higher the supply voltage to the LEDs, the fewer number of strings that will be required for a given design. With each string of LEDs consuming a typical 20-30 ma of current, limiting the number of strings required for a given design is critical to exploiting the greatest benefits of using LEDs, low current consumption versus conventional filament based lighting methods.

In our preferred embodiment of FIG. 1a, the design parameters are given as:

Rectifier diodes 22, 24, >50 v 1a

Electrolytic capacitors 26, 28, 150-480 mfd, >25 v

Precision positive voltage regulator 32

Supply voltage: >11 vac (typically 12-14 vac)

Supply current: >150 ma

Boosted voltage: >22 vdc (typically 23-28 vdc)

Output voltage: 20 vdc

Output current: >150 ma

As LEDs are current driven devices, voltage is only used to turn “on” the light emitting diode. As such, it is imperative to the life of the LED that the current be regulated as close as possible to the design specifications for a given LED or string of LEDs. Once an LED is turned “on”, applying additional voltage has no effect on the LED; specifically a given LED will only allow its designed voltage to pass. It is therefore self-limiting in this regard to supply voltage. Current is a different issue, as the LED once turned “on” effectively becomes a short circuit path for current flow offering only nominal impedance.

Why then have we decided to use a precision “voltage” regulator in our circuit design? It all comes down to the plurality of LED strings used in the design. Ideally you would design a circuit in which each string of LEDs would have a current regulator feeding it. This way each string would receive its designed current, typically 20-25 ma, and the designer would only need be concerned that there was ample voltage matching or exceeding the sum-total of all the LEDs in the string.

Ideal designs do not typically make good business choices in competitive markets. Therefore most LED designs use a plurality of LED strings in parallel from a single power source, thus reducing the number of components, package size, failure statistics, and most importantly cost. This however creates a dilemma for the designer; ideally there should be a one-to-one current regulator to LED string relationship. This is further complicated if the strings of LEDs are mixed colors, or manufactures. While typical LEDs all use the same current (20-25 ma), different color (frequency) LEDs used different voltages. Now factor in variances from manufacturer to manufacturer and the fact that LED current consumption changes with temperature due to internal voltage and impedance changes. One can quickly see that the “ideal” situation of using one current regulator to LED string is the only way to guaranty design success.

Since there is a relationship between voltage and current in a given design, we can apply a work-around to this design situation. If we can tie down the voltage to a precise value, thus eliminating one of the needed variables in the voltage/current relationship, we can precisely regulate current to each string of LEDs with the use of a current limiting resistor on each LED string. In summary, if the voltage is precisely set, then the current available to each individual LED string can be determined by design and regulated by a simple and cost-effective resistor.

Therefore, an attractive approach available for design consideration, when using a plurality of LED strings in parallel to a single supply source, is voltage regulation. This enhances the marketability and integrity of our product offering.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

The term “low-voltage switching power supply” is intended to include voltage supplies also designated as “electronic transformers” such as the disclosed 120/12 volt AC supply in the aforesaid Barak et al. patent.

What is claimed is:

1. A power conditioning circuit for providing a sufficient electrical load to a low-voltage switching power supply to excite the switching power supply, for enabling driving a light emitting diode load that may be coupled thereto comprising:
(a) a voltage multiplier means for providing a sufficient current inrush thereto from said low-voltage switching power supply to excite said low voltage switching power supply; and
(b) voltage regulator means, coupled to said voltage multiplier means, for producing a tightly controlled DC output voltage for maintaining the ideal designated current to said light emitting diode load that may be coupled to said voltage regulator means.

2. The power conditioning circuit of claim 1 wherein said voltage multiplier means has an input circuit having a sufficiently low electrical reactance for drawing an inrush current of sufficient magnitude and duration to excite said low-voltage switching power supply.

3. The power conditioning circuit of claim 2 wherein said input circuit includes at least one capacitor having a capacitance sufficient to draw said inrush current of sufficient magnitude and duration to excite said low voltage switching power supply.

4. The power conditioning circuit of claim 1 wherein said voltage multiplier means comprises at least one voltage multiplier having half-wave rectifiers for charging successive capacitors connected in series on alternate half-cycles.

5. The power conditioning circuit of claim 2 wherein said voltage multiplier means comprises at least one voltage multiplier having half-wave rectifiers for charging successive capacitors connected in series on alternate half-cycles.

6. The power conditioning circuit of claim 3 wherein said voltage multiplier means comprises at least one voltage multiplier having half-wave rectifiers for charging successive capacitors connected in series on alternate half-cycles.

7. A method of employing a low-voltage switching power supply for driving a light emitting diode load comprising the steps of:
(a) providing a power conditioning circuit having
(a-1) an input circuit for providing a sufficient current inrush therein, from a low-voltage switching power supply coupled to said input circuit, to excite said low voltage switching power supply, along with
(a-2) a voltage regulator, coupled to said input circuit, for producing a tightly controlled DC power conditioning circuit output voltage for maintaining the ideal designated current to a light emitting diode load that may be coupled said power conditioning circuit; and
(b) coupling said power conditioning circuit between said low-voltage switching power supply and a light emitting diode load.

8. The method of claim 7 including producing multiplication of the output voltage of said low-voltage switching power supply, enabling said voltage regulator to efficiently driving light emitting diode strings connected in parallel, each string having a substantial number of series connected light emitting diodes.

9. The method of claim 8 including doubling input voltages applied by said low-voltage switching power supply to said power conditioning circuit.

10. Lighting apparatus comprising:
(a) a low-voltage switching power supply;
(b) a light emitting diode load;
(c) a power conditioning circuit, coupled between said low-voltage switching power supply and said light emitting diode load, having a sufficiently low input reactance for drawing an inrush of current from said low-voltage switching power supply sufficient to excite the low-voltage switching power supply, for enabling driving of said light emitting diode load coupled thereto.

11. The lighting apparatus of claim 10 wherein said power conditioning circuit includes
(d) a voltage multiplier means having sufficiently low capacitive input reactance for drawing an inrush current of sufficient magnitude and duration to excite said low-voltage switching power supply; and
(e) voltage regulator means, coupled to an output circuit of said voltage multiplier, for producing a tightly controlled DC power conditioning circuit output voltage for maintaining the ideal designated current to said light emitting diode load coupled to said voltage regulator means.

12. The power conditioning circuit of claim 11 wherein said voltage multiplier means is a voltage doubler.

13. The power conditioning circuit of claim 11 wherein said voltage multiplier means comprises at least one voltage multiplier having half-wave rectifiers for charging successive capacitors connected in series on alternate half-cycles.

14. The power conditioning circuit of claim 12 wherein said voltage multiplier means comprises at least one voltage multiplier having half-wave rectifiers for charging successive capacitors connected in series on alternate half-cycles.

15. The power conditioning circuit of claim 10 wherein said light emitting diode load comprises light emitting diode strings connected in parallel, each string having a substantial number of series connected light emitting diodes.

16. The power conditioning circuit of claim 11 wherein said light emitting diode load comprises light emitting diode strings connected in parallel, each string having a substantial number of series connected light emitting diodes.

17. The power conditioning circuit of claim 12 wherein said light emitting diode load comprises light emitting diode strings connected in parallel, each string having a substantial number of series connected light emitting diodes.

18. The power conditioning circuit of claim 13 wherein said light emitting diode load comprises light emitting diode strings connected in parallel, each string having a substantial number of series connected light emitting diodes.

19. The power conditioning circuit of claim 14 wherein said light emitting diode load comprises light emitting diode strings connected in parallel, each string having a substantial number of series connected light emitting diodes.

20. The power conditioning circuit of claim 10 wherein said low-voltage switching power supply is configured to energize track lighting.
